(19) United States
(12) Patent Application Publication
(10) Pub. No.: US 2008/0091886 A1
(43) Pub. Date: Apr. 17, 2008

(54) Dynamic Path Determination To An Address Concentrator

(75) Inventors: Hiroaki Terakawa, Austin, TX (US); Jo Takeuchi, Austin, TX (US)

Correspondence Address: KAPLAN GILMAN GIBSON & DERNIER L.L.P., 900 ROUTE 9 NORTH, WOODBRIDGE, NJ, 07095, US

(73) Assignee: Sony Computer Entertainment Inc., Tokyo (JP)

(21) Appl. No.: 11/550,086

(22) Filed: Oct. 17, 2006

(51) Int. Cl. G06F 12/00

(52) U.S. Cl. 711/147

(57) ABSTRACT

Methods and apparatus provide for dynamically determining unit-AC paths between a plurality of processing units and a plurality of address concentrators. The unit-AC paths may be determined by configuring a plurality of selector settings of a plurality of selector circuits. The plurality of selector circuits, the plurality of selector settings and the plurality of address concentrators combine to enable a plurality of possible AC connections. The selector settings may be configured in accordance with a prioritization of the units and/or the unit-AC paths in view of a ranking of the plurality of possible AC connections. The unit-AC paths may be adjusted by reconfiguring the selector settings, such as when a priority mismatch is identified between the prioritization of the units and the ranking of AC connections. The methods and apparatus may also include updating one or more of the address concentrators regarding the current prioritization and/or selector settings in the system.

### BACKGROUND

The present invention relates to methods and apparatus for optimizing intra-processing system data transfers in data coherency management in distributed multi-processor systems. In particular, data transfer paths between processing units and address concentrators may be optimized using dynamic path determination and configuration.

In recent years, there has been an insatiable desire for faster computer processing data throughputs because cutting-edge computer applications involve real-time, multimedia functionality. Graphics applications are among those that place the highest demands on a processing system because they require such vast numbers of data accesses, data computations, and data manipulations in relatively short periods of time to achieve desirable visual results. These applications require extremely fast processing speeds, such as many thousands of megabits of data per second. While some processing systems employ a single processor to achieve fast processing speeds, others are implemented utilizing multi-processor architectures. In multi-processor systems, a plurality of sub-processors can operate in parallel (or at least in concert) to achieve desired processing results.

For example, a multi-processor system may include a plurality of processors all sharing a common system memory, where each processor also has a local memory in which to execute instructions. The multi-processor system may also include an external interface, for example, to connect with other processing systems and/or other external devices to permit the sharing of data and resources. While this can achieve significant benefits in functionality, processing power, etc., the sharing of data may require data coherency management in some circumstances.

### SUMMARY OF THE INVENTION

In accordance with one or more features described herein, methods and apparatus provide for dynamically determining unit-AC paths between a plurality of processing units and a plurality of address concentrators. The unit-AC paths may be determined, for example, by configuring selector settings of a plurality of selector circuits. As circumstances change, the unit-AC paths may be adjusted by reconfiguring the selector settings. The methods and apparatus may also include updating one or more of the address concentrators regarding the selector settings in the system. The determination is dynamic, as opposed to static, insofar as the determination can be changed.

The plurality of selector circuits, the plurality of selector settings and the plurality of address concentrators combine to enable a plurality of possible AC connections that may be ranked, i.e., from shortest to longest, fastest to slowest, best to worst, etc. The selector settings may be configured in accordance with a prioritization of the units and/or the unit-AC paths in view of the ranking of the plurality of possible AC connections. A change in the prioritization of the units and/or unit-AC paths may create a priority mismatch between a unit-AC path and its assigned AC connection. Hence, the current prioritization may differ from the former prioritization. A priority mismatch may occur where unit-AC path has a priority out of line with the rank of the assigned AC connection. If a priority mismatch is determined to exist, the plurality of selector settings may be adjusted to reconfigure the AC connections so as to alter the unit-AC paths in accordance with the current prioritization, thereby eliminating the priority mismatch. The methods and apparatus may also include updating the address concentrators regarding the current prioritization of the units and/or unit-AC paths.

In accordance with one or more further inventive aspects, a processing system includes: a plurality of processing units capable of being coupled to a shared memory; a plurality of address concentrators capable of being coupled to the processing units, the capability of coupling of the address concentrators and processing units enabling a plurality of possible AC connections; a plurality of selector circuits operable to determine unit-AC paths by forming AC connections according to selector settings; and a controller circuit operable to dynamically configure the selector circuits and/or set the selector settings according to a prioritization of the units and/or unit-AC paths.

In accordance with one or more further inventive aspects, an apparatus includes: a first processing system, including: a plurality of processing units capable of being coupled to a shared memory; a plurality of address concentrators capable of being coupled to the processing units, the capability of coupling of the address concentrator and units enabling a plurality of possible AC connections; and a plurality of selector circuits operable to determine unit-AC paths by forming AC connections according to selector settings. The apparatus may also include: at least one further processing system, each including: a plurality of further processing units; a plurality of further address concentrators; and a plurality of further selector circuits. The apparatus also may include a controller circuit operable to configure the selector circuits and/or set the selector settings according to a prioritization of the units and/or unit-AC paths. The controller circuit is preferably operable also to configure the further selector circuits and/or set the further selector settings of the further selector circuits according to a prioritization of the units and/or unit-AC paths among the first processing system and plurality of other processing systems.

A preferred implementation of the present invention may utilize a microprocessor architecture known as Cell Broadband Engine Architecture, commonly abbreviated “CBEA,” “Cell BE,” or simply “Cell.” The CBEA combines a light-weight general-purpose POWER-architecture core of modest performance with multiple GPU-like streamlined coprocessing elements into a coordinated whole, with a sophisticated memory coherence architecture. POWER is a backronym for “Performance Optimization With Enhanced RISC” and refers to a RISC instruction set architecture, as well as a series of microprocessors that implements the instruction set architecture.

The CBEA greatly accelerates multimedia and vector processing applications, as well as many other forms of dedicated computation. The CBEA emphasizes efficiency over watts, bandwidth over latency, and peak computational throughput over simplicity of program code.

The CBEA can be split into four components: external input and output structures; the main processor called the POWER Processing Element (“PPE”) (a two-way simultaneous multithreaded POWER 970 architecture compliant core); eight fully functional co-processors called the Synergistic Processing Elements (“SPEs”); and a specialized high bandwidth circular data bus connecting the PPE, input/output elements and the SPEs, called the Element Interconnect Bus (“EIB”). To achieve the high performance needed for mathematically intensive tasks such as decoding/encoding MPEG streams, generating or transforming three dimensional data, or undertaking Fourier analysis of data, the CBEA marries the SPEs and the PPE via the EIB to give the SPEs and the PPE access to main memory or other external data storage.

Within the Cell Broadband Engine Architecture, a Broadband Engine (BE) may include one or more PPEs. The PPE is capable of running a conventional operating system and has control over the SPEs, allowing it to start, stop, interrupt and schedule processes running on the SPEs. To this end, the PPE has additional instructions relating to control of the SPEs. Despite having Turing complete architectures, the SPEs are not fully autonomous and require the PPE to initiate them before they can do any useful work. Most of the “horsepower” of the system comes from the synergistic processing elements, SPEs.

Each SPE is composed of a “Streaming Processing Unit” (“SPU”), and a Synergistic Memory Flow (SMF) controller unit. The SMF may have a digital memory access (DMA), a memory management unit (MMU), and a bus interface. An SPE is a RISC processor with 128-bit single-instruction, multiple-data (SIMD) organization for single and double precision instructions. With the current generation of the CBEA, each SPE contains a 256 KiB instruction and data local memory area (called “local store”) which is visible to the PPE and can be addressed directly by software. Each of these SPE can support up to 4 GB of local store memory, as static random access memory (SRAM). The local store does not operate like a conventional CPU cache since it is neither transparent to software nor does it contain hardware structures that predict what data to load.

An exemplary CBEA multiprocessing system may have eight valid SPEs in a common IC, giving it much flexibility in product implementation. For instance, as the CBEA is manufactured, one of the SPEs may become faulty and, therefore, the overall performance of the IC may be reduced. Instead of discarding the IC, the reduced performance multiprocessing system may be used in an application (e.g., a product) that does not require a full complement of SPEs. For example, a high performance video game product may require a full complement of SPEs; however, a digital television (DTV) might not require a full complement of SPEs. Depending on the complexity of the application in which the multi-processing system is to be used, a lesser number of SPEs may be employed by disabling the faulty SPE and using the resulting multiprocessing system in a less demanding environment (such as a DTV).

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, there are shown in the drawings, wherein like numerals indicate like elements, forms that are presently preferred, it being understood, however, that the invention is not limited to the precise arrangements and instrumentalities shown, but instead only by the claims.

FIG. 1 is a block diagram illustrating the structure of a multiprocessing system having two or more sub-processors in accordance with one or more aspects of the present invention.

FIG. 2 is a block diagram illustrating the structure of a distributed system having two or more processing systems interconnected in accordance with one or more aspects of the present invention.

FIG. 3 is a simplified block diagram of an exemplary multiprocessing system.

FIG. 4 is a simplified block diagram of an exemplary tree structure of an address concentrator hierarchy of the multiprocessing system depicted in FIG. 3.

FIG. 5 is a simplified block diagram of the exemplary multiprocessing system of FIG. 3 depicted as having been modified to include exemplary selector circuits and a controller.

FIG. 6 is a simplified block diagram of an exemplary tree structure of the address concentrator hierarchy of the multiprocessing system depicted in FIG. 5.

FIG. 7 is a flow diagram illustrating exemplary process steps that may be carried out by system of FIG. 5.

FIG. 8 is a simplified block diagram of the exemplary tree structure of FIG. 6 depicted as having been modified to include the re-configurations of paths and the re-assignments of connections set forth in FIG. 7.

FIG. 9 is a diagram illustrating a broadband engine (BE) that may be used to implement one or more further aspects of the present invention.

FIG. 10 is a diagram illustrating the structure of an exemplary synergistic processing element (SPE) of the system of FIG. 9 that may be adapted in accordance with one or more further aspects of the present invention.

FIG. 11 is a diagram illustrating the structure of an exemplary POWER processing element (PPE) of the system of FIG. 9 that may be adapted in accordance with one or more further aspects of the present invention.

### DETAILED DESCRIPTION OF THE PRESENT INVENTION

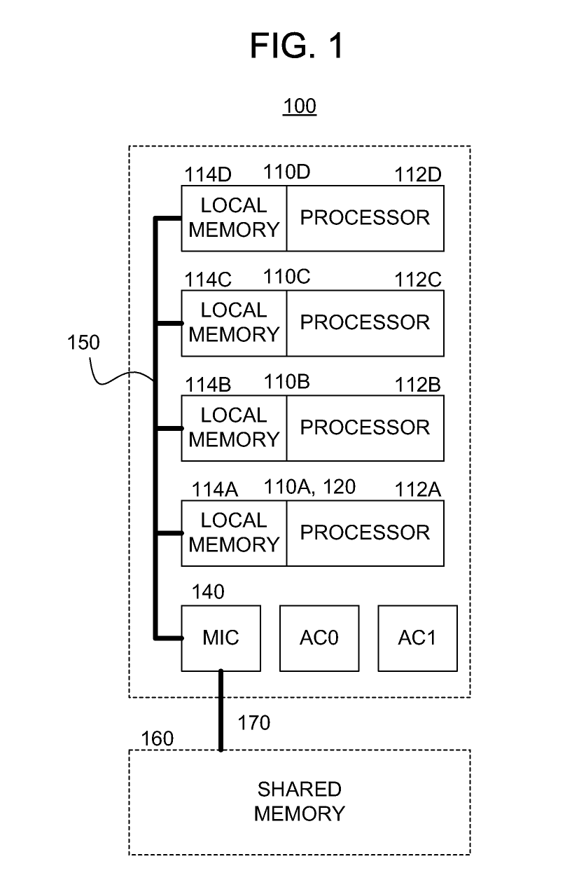

Referring to FIG. 1, a processing system 100 suitable for implementing one or more features of the present invention is shown. For the purposes of brevity and clarity, the block diagram of FIG. 1 will be referred to and described herein as illustrating an apparatus, it being understood, however, that the description may readily be applied to various aspects of a method with equal force.

The processing system 100 includes a plurality of processors 110A, 110B, 110C, and 110D, it being understood that any number of processors may be employed without departing from the spirit and scope of the invention. The processing system 100 also preferably includes a memory interface circuit 140, a shared memory 160, and first and second address concentrators AC0, AC1, respectively. At least the processors 110A, 110B, 110C, 110D, and the memory interface circuit 140 are preferably coupled to one another over a bus system 150 that is operable to transfer data to and from each component in accordance with suitable protocols.

Each of the processors 110A, 110B, 110C, 110D may be of similar construction or of differing construction. The processors may be implemented utilizing any of the known technologies that are capable of requesting data from the shared (or system) memory 160, and manipulating the data to achieve a desirable result. For example, the processors 110A, 110B, 110C, 110D may be implemented using any of the known microprocessors that are capable of executing software and/or firmware, including standard microprocessors, distributed microprocessors, etc. By way of example, one or more of the processors 110A, 110B, 110C, 110D may be a graphics processor that is capable of requesting and manipulating data, such as pixel data, including gray scale information, color information, texture data, polygonal information, video frame information, etc.

In an alternative embodiment, one or more of the processors 110A, 110B, 110C, 110D of the system 100 may take on the role as a main (or managing) processor 120. The system 100 may include a main processor 120, e.g. processor 110A, operatively coupled to the other processors 110B, 110C, 110D and capable of being coupled to the shared memory 160 over the bus system 150. The main processor 120 may schedule and orchestrate the processing of data by the other processors 110B, 110C, 110D. Unlike the other processors 110B, 110C, 110D, however, the main processor 120 may be coupled to a hardware cache memory, which is operable cache data obtained from at least one of the shared memory 160 and one or more of the local memories of the processors 110A, 110B, 110C, 110D. The main processor 120 may provide data access requests to copy data (which may include program data) from the system memory 160 over the bus system 150 into the cache memory for program execution and data manipulation utilizing any of the known techniques, such as DMA techniques.

The memory interface circuit 140 is preferably operable to facilitate data transfers between the processors 110A, 110B, 110C, 110D and the shared memory 160 such that the processors 110 may execute application programs and the like. By way of example, the memory interface circuit 140 may provide one or two high-bandwidth channels 170 into the shared memory 160 and may be adapted to be a slave to the bus system 150. Any of the known memory interface technologies may be employed to implement the memory interface circuit 140.

The system memory 160 is preferably a dynamic random access memory (DRAM) coupled to the processors 110A, 110B, 110C, 110D through the memory interface circuit 140. Although the system memory 160 is preferably a DRAM, the memory 160 may be implemented using other means, e.g., a static random access memory (SRAM), a magnetic random access memory (MRAM), an optical memory, a holographic memory, etc.

Turning again to the processors, each processor 110A, 110B, 110C, 110D preferably includes a processor core 112 (e.g., 112A-D) and a local memory 114 (e.g., 114A-D) in which to execute programs. These components may be integrally disposed on a common semi-conductor substrate or may be separately disposed as may be desired by a designer. The processor core 112 is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the processor core 112 may include an instruction buffer, instruction decode circuitry, dependency check circuitry, instruction issue circuitry, and execution stages.

The local memory 114 is coupled to the processor core 112 via a bus and is preferably located on the same chip (same semiconductor substrate) as the processor core 112. The local memory 114 is preferably not a traditional hardware cache memory in that there are no on-chip or off-chip hardware cache circuits, cache registers, cache memory controllers, etc. to implement a hardware cache memory function. As on chip space is often limited, the size of the local memory 114 may be much smaller than the shared memory 160.

The processors 112 preferably provide data access requests to copy data (which may include program data) from the system memory 160 over the bus system 150 into their respective local memories 114 for program execution and data manipulation. The mechanism for facilitating data access may be implemented utilizing any of the known techniques, for example the direct memory access (DMA) technique.

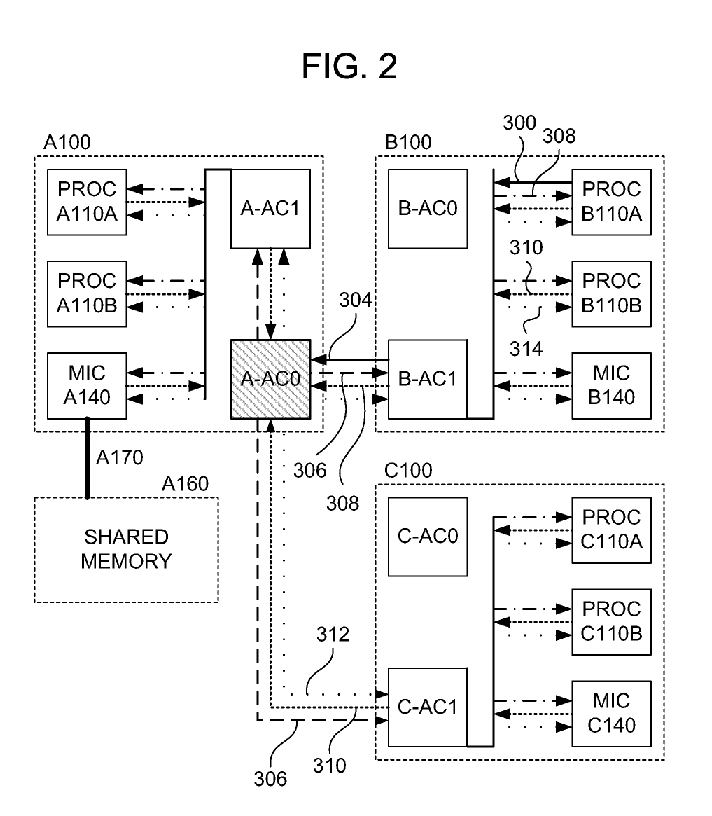

The first and second address concentrators AC0, AC1 are operable, inter alia, to facilitate data coherency as between the processing system 100 and any other external devices, such as other processing systems. The address concentrator may be an architectural concept that can be integrated into an external device or as part of the multiprocessor system 100. The address concentrator may be responsible for receiving command packets from both the system 100 and external devices and selecting the order in which these commands are processed. After the order is determined, the address concentrator may send out a reflected command packet to both the system 100 and the external devices. The details as to the function and operation of the address concentrators AC0, AC1 will be discussed in more detail herein below with reference to FIG. 2 et seq.

Generally speaking, however, the address concentrator AC0 is a circuit to which data access commands are sent, and from which the commands are reflected to other devices, such as the sub-processors 110, the main processor 120, the memory interface controller 140, etc. The AC0 receives responses from these devices indicating whether the data associated with a given data command are currently being manipulated or otherwise not current in the shared memory. If the responses indicate that the data are current (i.e., no other device is manipulating the data), the processor 110 issuing the data command may obtain the data from the shared memory 160. This coherency technique is applied to multiple systems A100, B100, C100, etc., by designating one AC0 among the systems 100 to provide the address concentration function.

In other words, command packets may contain address and control information that describes the transaction to be preformed on the system. An address concentrator may receive the command packets, determine the order in which the commands are processed, and select a command. The selected command packet may be sent (reflected) by a master device to a slave device on the system in the format of a reflected command. After receiving a reflected command packet, the slave may send a reply to the master in the form of a snoop response packet. The snoop response packet may indicate the acceptance or rejection of the reflected command packet. In some cases, the slave may not be the final destination for the transaction, in which case the slave is responsible for forwarding the request to the final destination, usually without generating a snoop response packet.

Typically, a command packet is a request for a data transaction. For requests such as coherency management and synchronization, the command packet may be the complete transaction. When the request is for a data transaction, data packets containing control information and the requested data may be transferred between the master and slave. Depending on the transport layer definition, command and data packets may be sent and received simultaneously by both devices on the system. Coherency is maintained by reflecting command packets to all snoopers (e.g., devices that may have cached data) in the system. Each device that receives a reflected command packet may send a snoop response packet that may contain the coherency action required by the snooper. The snoop response packets from all snoopers may be combined together to form the accumulated snoop response packet sent to all devices in the system.

Referring to FIG. 2, a plurality of processing systems A100, B100, C100, etc., may be coupled to one another by way of appropriate networking protocols. Each of the processing systems may have the structure shown in FIG. 1 and/or similar constructions. To achieve this interconnection between systems, each processing system 100 may include an external interface circuit (not shown) that is adapted to facilitate data transfers between, for example, the system A100 and one or more of the other systems B100, C100 over a communications channel, such as a bus extension. Preferably, the external interface circuit is adapted to exchange non-coherent traffic with an external device and/or operate coherently by extending the bus system 150 to the other processing systems. Although any of the known external interface technologies may be employed to implement the external interface circuit, it is preferred that the circuit combines command and data into packetized envelopes and insures successful delivery of the envelopes to/from the external device.

Each of the processors 110 (only processors 110A and 110B being shown per system 100) is preferably operable to obtain data stored in any of the shared memories 160, including its own shared memory 160 and the shared memories 160 of the other processing systems 100. For example, the processor B110A of the processing system B100 is preferably operable to obtain data from and store data in the shared memory A160 of the processing system A100. In this regard, the memory space seen by each processor may encompass all or some of the shared memories 160. Under these circumstances, it may be desirable to maintain data coherency as to data that may be obtained by any particular processor. At least part of the data coherency scheme is preferably carried out by the address concentrators AC0 and AC1 of one or more of the processing systems 100.

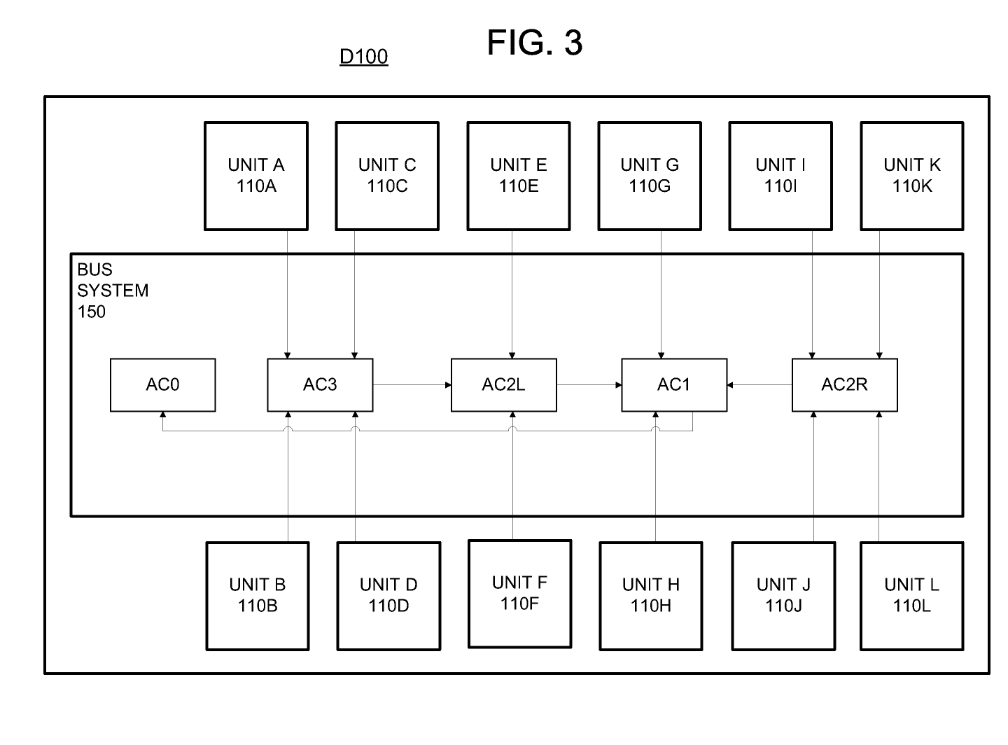

Data coherency may be achieved in accordance with some inventive aspects using the function and operation of the address concentrators AC0, AC1. As will be discussed in later FIG. 3 et seq., more address concentrators may be used as needed. In this regard, it is assumed for the purposes of this discussion that data coherency among three processing systems A100, B100 and C100 is desired. If one of the processors 110, e.g., processor 102B, issues a data command requesting data stored in one of the processing systems 100, the data command may be sent to the second address concentrator B-AC1 of the processing system B100.

Assuming that only the first address concentrator A-AC0 of the processing system A100 is engaging in coherency management, then the other first address concentrators B-AC0 and C-AC0 may be dormant if not needed, given the number of processors 110 per system B100 and C100. In this example, the second address concentrator B-AC1 of the processing system B100 preferably sends the data command to the first address concentrator A-AC0 of the processing system A100. The first address concentrator A-AC0 then may broadcast the data command issued by the processor 102B to the second address concentrators A-AC1, B-AC1, C-AC1.

The first address concentrator A-AC0 of the processing system A100 (the selected processing system) is preferably operable to broadcast the data command to the second address concentrator AC1 in each of the processing systems, i.e., A-AC1, B-AC1, C-AC1. Each of the second address concentrators A-AC1, B-AC1, C-AC1 is preferably operable to broadcast the data command to each of the plurality of processors (and/or other devices, such as the MIC 140 or other address concentrators as needed) in its processing system 100. It is noted that each address concentrator AC0, AC1 may be operable to merge a plurality of broadcasted data commands in the event that more than one first address concentrator AC0 broadcasts a respective data command to the second address concentrator AC1.

In response to the broadcasted data command within each processing system 100, each of the address concentrators AC0, AC1 is preferably operable to receive coherency responses from the processors (and/or other devices) in its processing system. Thus, for example, the second address concentrator CAC1 may receive a coherency response from each of processor C110A, processor C110B, and MIC C140. Next, each of the address concentrators AC0, AC1 is preferably operable to send the coherency responses to the first address concentrator A-AC0 of the selected processing system A100.

The first address concentrator A-AC0 is preferably operable to combine the coherency responses and broadcast the combined coherency responses to the first and/or second address concentrator AC0, AC1 in each of the processing systems 100. In response, the respective first and/or second address concentrators AC0, AC1 are operable to broadcast the combined coherency responses to each of the processors (and/or other devices) within its processing system. Each address concentrator AC0, AC1 may be operable to merge the combined coherency responses prior to broadcasting them to the processors (and/or other devices) when more than one first address concentrator AC0 is managing a coherency action.

In some instances, it may be desirable to limit the extent of the data coherency objective, such as between only two processing systems A100, B100. For instance, system C100 may serve an unrelated function or may be a redundant system that is inactive or disabled. In this scenario, significantly less control traffic is necessary to achieve the data coherency objective.

Referring to FIG. 3, a simplified block diagram of an exemplary multiprocessing system D100 is depicted. In system D100, there are 12 processors 110 (e.g., units A-L, 110A-L) interconnected by a bus system 150. Maintaining data coherency in system D100 would be a challenge, so multiple address concentrators may be used. In FIG. 3, there are address concentrators AC0, AC1, AC2L, AC2R and AC3.

The AC architecture may be hierarchical in nature, with each AC generally forming connections with up to four units. If a multiprocessor system has more than four units, more than one AC level may be used and arranged in a hierarchical tree structure, with AC block levels lower on the tree (e.g., AC0) connecting to multiple AC block levels higher on the tree (e.g., AC1, AC2, etc.). The various AC block levels form AC connections that vary in length, speed, efficiency, etc., and as such may be ranked accordingly. As the units are interconnected by the bus 150, the commands are sent to the bus 150 through the AC blocks. Commands are chosen by the AC round-robin-style and sent to the next level of AC blocks.

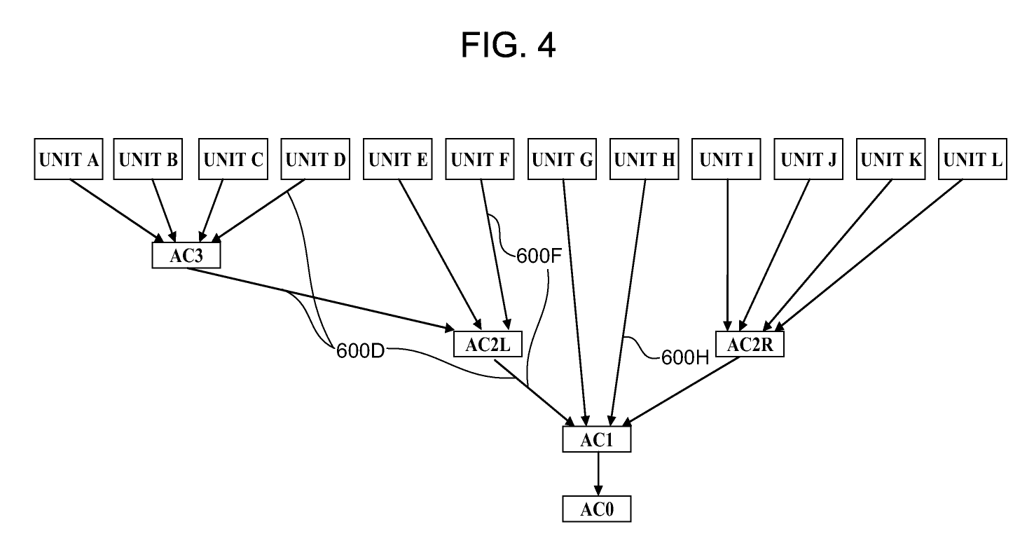

Referring to FIG. 4, a simplified block diagram of an exemplary tree structure of the AC hierarchy of multiprocessing system D100 is depicted. For example, for system D100 with 12 units, units A-L, there may be four levels of AC blocks, AC0-AC3. Each unit has a unit-AC path 600, such as unit-AC paths 600D, 600F, and 600H for unit D, unit F, and unit H. If unit C connects to AC3, a branch of AC2L, a branch of AC1, a branch of AC0, then a command from unit C will pass through AC3, AC2L, AC1, and AC0. In the same system, path 600H of unit H may be connected directly to AC1, so a command from unit H will pass through AC1 and AC0.

The shorter or more direct the cumulative path 600 from the unit to AC1, the more efficient the path 600 between the unit and the AC. Thus, units G and H have the shortest, most direct and efficient paths 600 of the system D100. Accordingly, the AC connection forming path 600H, for instance, may be ranked higher than that of path 600D. To the extent that the AC connections define various possible routes that may be taken by the paths 600, the AC connection combinations may create a fixed hierarchy of cumulative route lengths, from shortest to longest, etc. Although the prioritization of the units may change, the ranking and/or hierarchy of the AC connections unlikely will change.

In the event, however, that unit H is a faulty unit, unit H will be disabled, and the path 600H from unit H to AC1 is not used, thereby making one of the two shortest, most direct and efficient paths not useable. In order to overcome this dilemma, the present invention provides a system for dynamic path determination between the units and the AC to optimize the available path length.

The available unit-AC paths 600 are used more effectively through dynamic replacement of unit connections, in the event that a wrong unit is occupying a shorter path 600 that may be made available to another unit. More broadly speaking, the units as well as the unit-AC paths 600 may be prioritized, and the unit-AC paths 600 may be reconfigured if and when the unit-AC path prioritization does not match the unit prioritization, creating a prioritization mismatch.

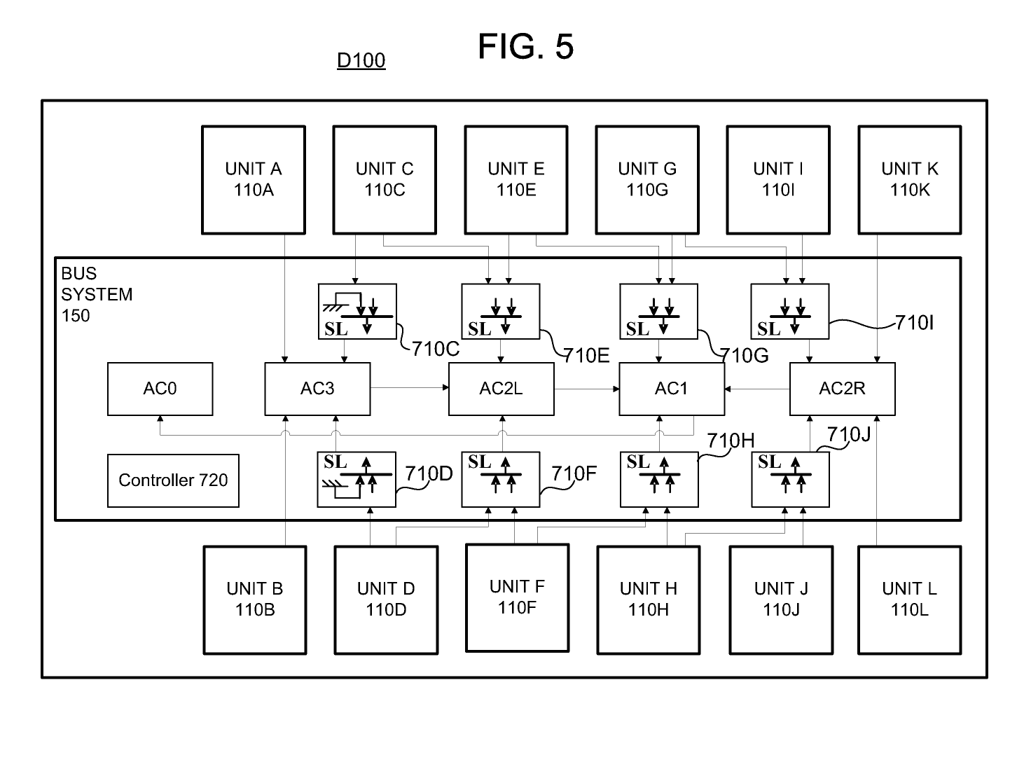

Referring to FIG. 5, the simplified block diagram of the exemplary multiprocessing system D100 of FIG. 3 is depicted as having been modified to include exemplary selector circuits 710 (e.g., 710C-J) and a controller 720. In system D100, the 12 processors 110, units A-L, interconnected by a bus system 150, are now shown as connecting to selector circuits 710C-J to further connect to address concentrators AC0, AC1, AC2L, AC2R and AC3.

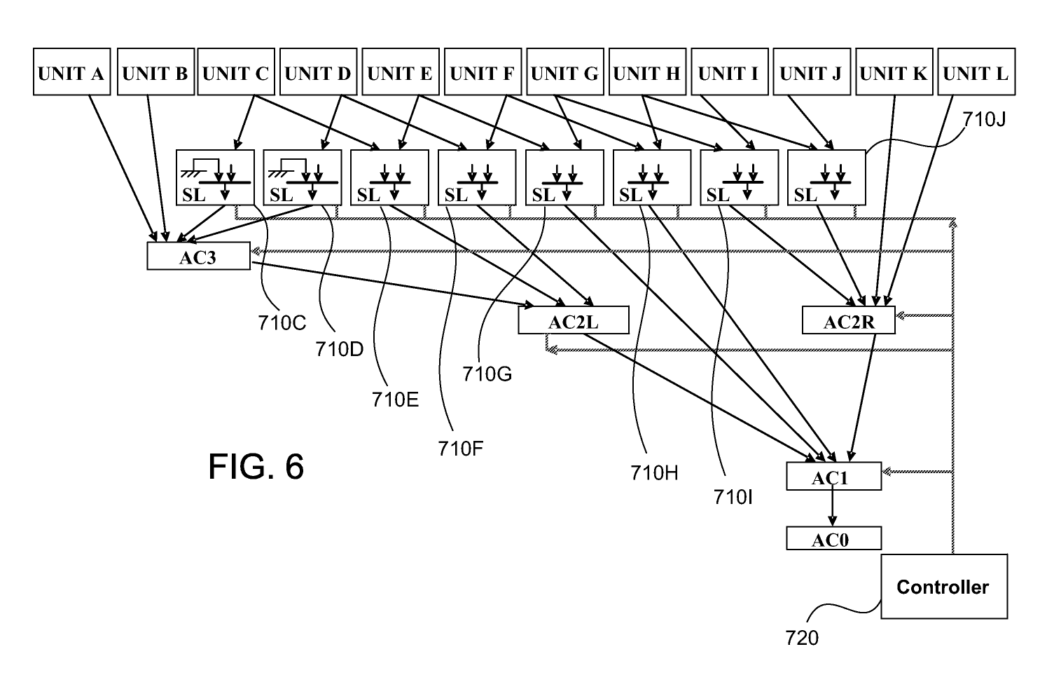

Referring to FIG. 6, the simplified block diagram of the exemplary tree structure of FIG. 4 is depicted as having been modified to include exemplary selector circuits 710 (e.g., 710C-J) and a controller 720 shown in FIG. 5. The plurality of selector circuits 710, the associated selector settings, and the plurality of address concentrators combine to enable a plurality of possible AC connections that may be ranked, i.e., from shortest to longest, fastest to slowest, best to worst, etc. The selector settings may be configured in accordance with a prioritization of the units and/or the unit-AC paths in view of the ranking of the plurality of possible AC connections.

If a prioritization mismatch occurs, such as when a wrong unit has a given unit-AC path 600, a path controller 720 reorganizes the AC connections, thereby reassigning the unit-AC paths 600, to select the best path 600 for each unit to the AC. The path controller 720 accomplishes the dynamic path determination and configuration using selector circuits 710 between the units and the AC blocks. The path controller 720 configures the selection settings of these selector circuits 710 and communicates the selection settings information to the AC blocks. When a unit is determined to be wrong, but its path 600 is short and active, i.e., of higher priority, the path controller 720 can configure the selector circuits 710 to assign this short, higher priority path to the unit with the next most appropriate priority. As a new path 600 becomes available, the unit connections are reshuffled according to unit priority. Thus, the paths 600 between the units and AC are used more effectively with no effect on the command issuance process.

The selector circuits 710C-J are shown in FIG. 5 as being inserted between each of the units C-J and the ACs. In an attempt to simplify the illustration in FIG. 5, no selector circuits are depicted for unit A, unit B, unit L and unit K, although actual embodiments may have a selector circuit 710 for each unit. Likewise as a matter of simplification, the selector circuits 710 are shown as selecting between two units connected to the selector circuit 710, but any logical configuration of selector circuits 710 is possible. The controller 720 can configure the settings of these selector circuits 710 within the logic parameters of the configuration. The controller 720 also may maintain the information about the selector settings and periodically update each AC.

For example, the controller 720 may define three priority groups. The lowest priority units are assigned to connect through the lowest priority unit-AC paths using the lowest ranking AC connections via the most hierarchically-remote ACs in Group 3. In FIG. 4, unit A, unit B, unit C, and unit D are assigned to Group 3. The highest priority units are assigned to connect through the highest priority unit-AC paths using the highest ranking AC connections via the least hierarchically-remote ACs in Group 1. In FIG. 4, unit G and unit H are assigned to Group 1. The other units are assigned to connect through the middle priority unit-AC paths using the middle ranking AC connections via the less hierarchically remote ACs in Group 2. In FIG. 4, unit E, unit F, unit I, unit J, unit K, and unit L are assigned to Group 2.

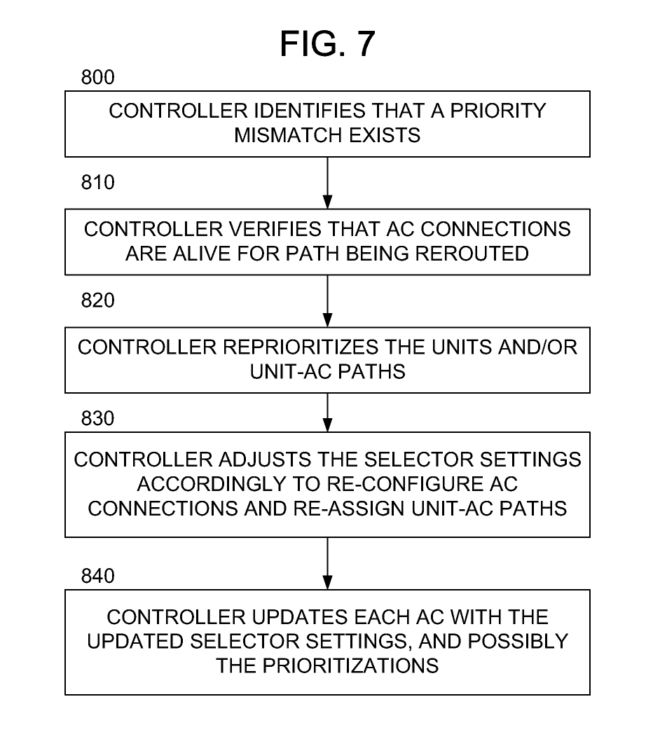

Referring to FIG. 7, a flow diagram illustrates exemplary process steps that may be carried out by system of FIG. 5 in managing unit-AC paths. In the above example of FIG. 6, if a priority mismatch exists with unit H, then the unit H path 600H will be rerouted. For instance, the controller 720 may identify or determine (action 800) that a priority mismatch exists to the extent that unit H may be a wrong unit and has been disabled. The controller 720 may verify (action 810) whether AC connection forming the path 600 previously occupied by path 600H is alive, so that another unit can use the route that path 600H formerly occupied. Similarly, the controller 720 may reprioritize (action 820) the units and/or unit-AC paths according to this new information. As such, the controller would adjust (action 830) the selector settings based on the update prioritizations so that path 600F of unit F of Group 2 uses the AC connections previously occupied by path 600H of unit H in Group 1. Likewise, path 600D of unit D of Group 3 would use the AC connections previously occupied by path 600F of unit F in Group 2. After the paths 600 have been rerouted and the AC connections reassigned, the controller 720 may update (action 840) each AC regarding the selector settings, and possibly the new prioritization information. This dynamic re-configuration may use effectively all of the available paths 600 between units and ACs without affecting the command issuance process.

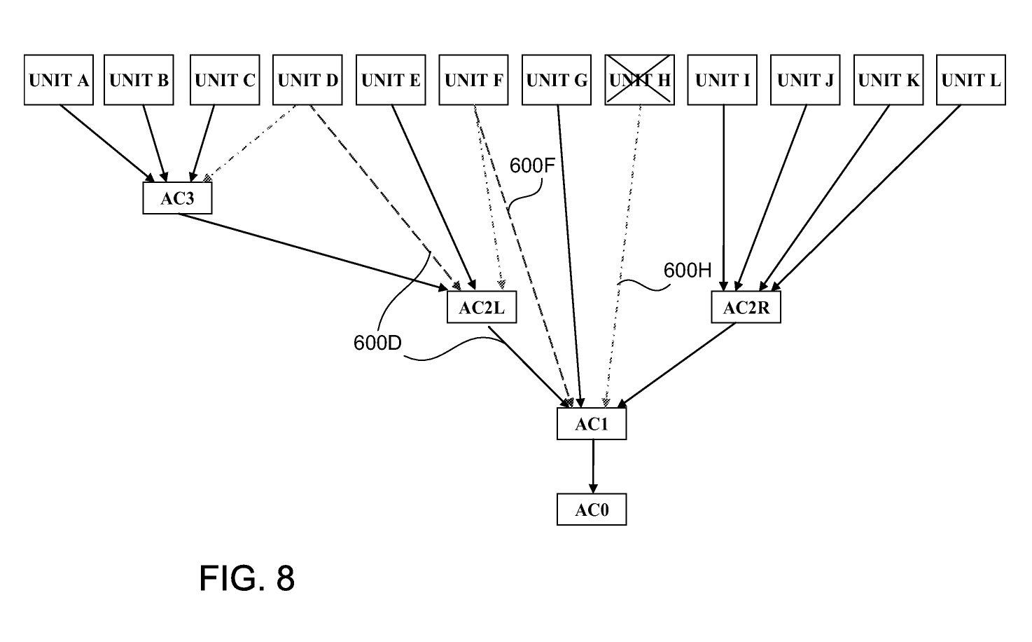

Referring to FIG. 8, the simplified block diagram of the exemplary tree structure of FIG. 4 is depicted as having been modified to include the re-configurations of paths 600 and the re-assignments of connections set forth in FIG. 7. In FIG. 8, the dash-dotted lines leading from unit D, unit F and unit H represent the former routes taken by paths 600D, 600F and 600H. In contrast, the long dashed lines leading from unit D and unit F represent the new routes assigned to paths 600D and 600F. Path 600H was not reassigned, insofar as unit H was disabled.

Moreover, as in FIG. 2, multiple systems 100 may be combined, and one controller circuit 720 may control the configuration of the selector settings for the various selector circuits 710 among the systems 100. Where one AC0 is engaging in coherency management for the combination of systems, this AC0 functions as the trunk of the tree structure, so all unit-AC paths 600 of the multiple systems 100 eventually lead to this AC0, so a combined prioritization may exist. However, within a given system 100 of the multiple systems 100, a sub-prioritization may exist that may be partially independent of other sub-prioritizations within the other systems 100, insofar as the given plurality of possible AC connections of the given system may be independent at the branch level from other pluralities of possible AC connections of the other systems. This limited independence may arise due to the physical and logical network arrangements of multiple pluralities of selector circuits.

For instance, referring to FIG. 5, units A-F might comprise a first system having a first prioritization while units G-L might comprise a second system having a second prioritization, the first and second prioritizations being sub-prioritizations of a prioritization set of the apparatus comprising the first and second systems. Inasmuch as the first and second prioritizations intersect at AC1 in FIG. 6, the elimination of path 600H in FIG. 8 opens an AC connection at AC1 that is depicted as being transferred from unit H to unit F. Hence, the AC connection is transferred from the second system to the first system in view of the first prioritization, the second prioritization, and the first prioritization relative the second prioritization within the prioritization set.

In accordance with one or more embodiments, the multi-processor system 100 may be implemented as a single-chip solution operable for stand-alone and/or distributed processing of media-rich applications, such as game systems, home terminals, PC systems, server systems and workstations. In some applications, such as game systems and home terminals, real-time computing may be a necessity. For example, in a real-time, distributed gaming application, one or more of networking image decompression, 3D computer graphics, audio generation, network communications, physical simulation, and artificial intelligence processes have to be executed quickly enough to provide the user with the illusion of a real-time experience. Thus, each processor in the multi-processor system 100 must complete tasks in a short and predictable time.

To this end, and in accordance with this computer architecture, all processors of a multi-processing computer system 100 are constructed from a common computing module (or cell). This common computing module has a consistent structure and preferably employs the same instruction set architecture. The multi-processing computer system 100 can be formed of one or more clients, servers, PCs, mobile computers, game machines, PDAs, set top boxes, appliances, digital televisions and other devices using computer processors.

A plurality of the computer systems 100 also may be members of a network if desired. The consistent modular structure enables efficient, high speed processing of applications and data by the multi-processing computer system, and if a network is employed, the rapid transmission of applications and data over the network. This structure also simplifies the building of members of the network of various sizes and processing power and the preparation of applications for processing by these members.

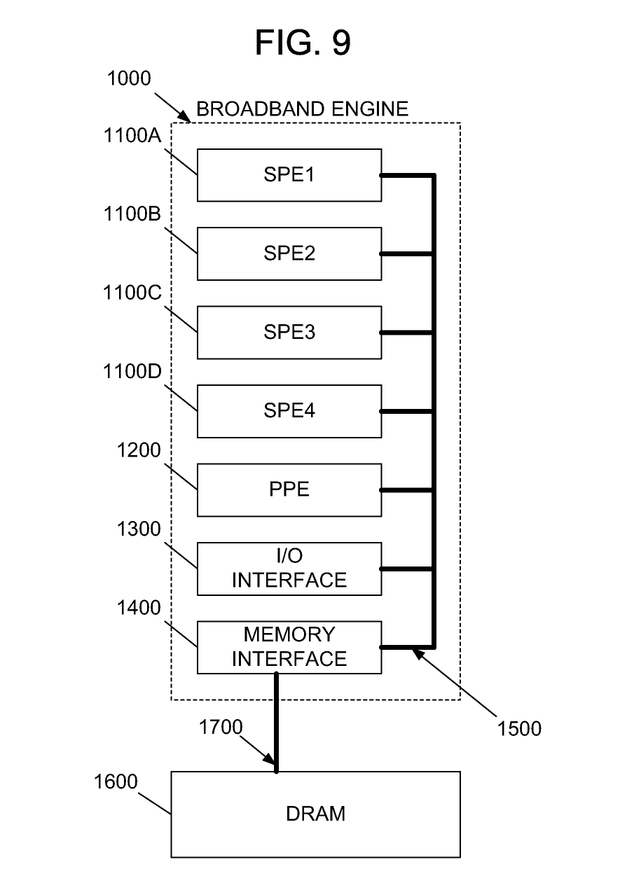

A description of a preferred computer architecture for a multi-processor system is provided in FIGS. 9-11 that is suitable for carrying out one or more of the features discussed herein.

Referring to FIG. 9, a preferred structure of a basic processing module is shown as a broadband engine (BE) 1000. The BE 1000 comprises an I/O interface 1300, a POWER processing element (PPE) 1200, and a plurality of synergistic processing elements 1100, namely, synergistic processing element 1100A, synergistic processing element 1100B, synergistic processing element 1100C, and synergistic processing element 1100D. A local (or internal) BE bus 1500 transmits data and applications among the PPE 1200, the synergistic processing elements 1100, and a memory interface 1400. The local BE bus 1500 can have, e.g., a conventional architecture or can be implemented as a packet-switched network. If implemented as a packet switch network, while requiring more hardware, increases the available bandwidth.

The BE 1000 can be constructed using various methods for implementing digital logic. The BE 1000 preferably is constructed, however, as a single integrated circuit employing a complementary metal oxide semiconductor (CMOS) on a silicon substrate. Alternative materials for substrates include gallium arsinide, gallium aluminum arsinide and other so-called III-B compounds employing a wide variety of dopants. The BE 1000 also may be implemented using superconducting material, e.g., rapid single-flux-quantum (RSFQ) logic.

The BE 1000 is closely associated with a shared (main) memory 1600 through a high bandwidth memory connection 1700. Although the memory 1600 preferably is a dynamic random access memory (DRAM), the memory 1600 could be implemented using other means, e.g., as a static random access memory (SRAM), a magnetic random access memory (MRAM), an optical memory, a holographic memory, etc.

The PPE 1200 and the synergistic processing elements 1100 are preferably each coupled to a memory flow controller (MFC) including direct memory access DMA functionality, which in combination with the memory interface 1400, facilitate the transfer of data between the DRAM 1600 and the synergistic processing elements 1100 and the PPE 1200 of the BE 1000. It is noted that the DMAC and/or the memory interface 1400 may be integrally or separately disposed with respect to the synergistic processing elements 1100 and the PPE 1200. Indeed, the DMAC function and/or the memory interface 1400 function may be integral with one or more (preferably all) of the synergistic processing elements 1100 and the PPE 1200. It is also noted that the DRAM 1600 may be integrally or separately disposed with respect to the BE 1000. For example, the DRAM 1600 may be disposed off-chip as is implied by the illustration shown or the DRAM 1600 may be disposed on-chip in an integrated fashion.

The PPE 1200 can be, e.g., a standard processor capable of stand-alone processing of data and applications. In operation, the PPE 1200 preferably schedules and orchestrates the processing of data and applications by the synergistic processing elements. The synergistic processing elements preferably are single instruction, multiple data (SIMD) processors. Under the control of the PPE 1200, the synergistic processing elements perform the processing of these data and applications in a parallel and independent manner. The PPE 1200 is preferably implemented using a PowerPC core, which is a microprocessor architecture that employs reduced instruction-set computing (RISC) technique. RISC performs more complex instructions using combinations of simple instructions. Thus, the timing for the processor may be based on simpler and faster operations, enabling the microprocessor to perform more instructions for a given clock speed.

It is noted that the PPE 1200 may be implemented by one of the synergistic processing elements 1100 taking on the role of a main processing unit that schedules and orchestrates the processing of data and applications by the synergistic processing elements 1100. Further, there may be more than one PPE implemented within the broadband engine 1000.

In accordance with this modular structure, the number of BEs 1000 employed by a particular computer system is based upon the processing power required by that system. For example, a server may employ four BEs 1000, a workstation may employ two BEs 1000 and a PDA may employ one BE 1000. The number of synergistic processing elements 1100 of a BE 1000 assigned to processing a particular software cell depends upon the complexity and magnitude of the programs and data within the cell.

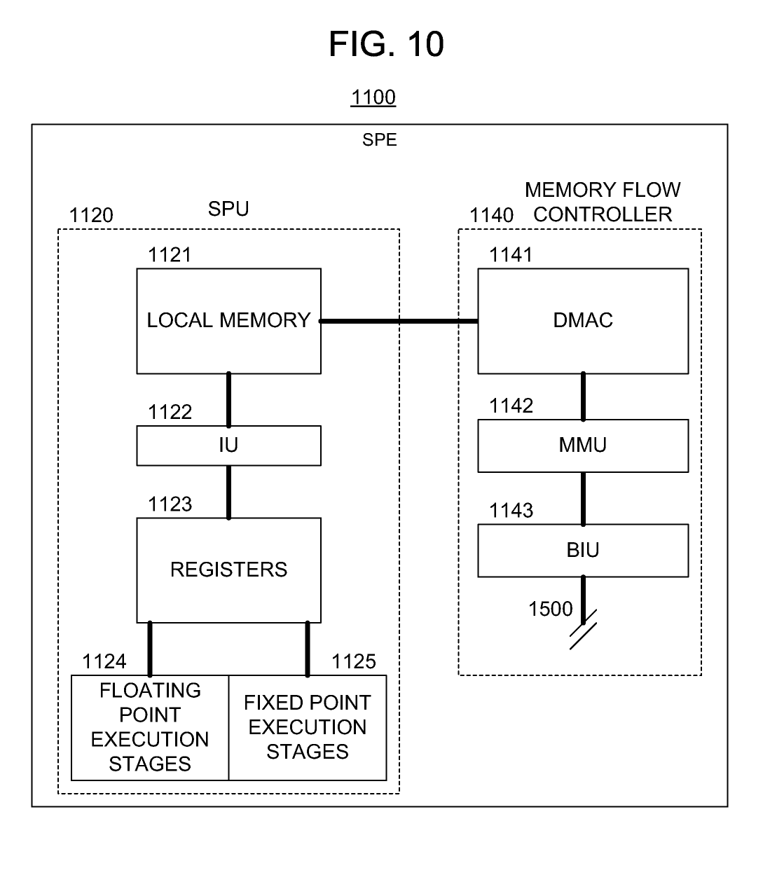

Referring to FIG. 10, a preferred structure of a synergistic processing element (SPE) 1100 is illustrated. The SPE 1100 architecture preferably fills a void between general-purpose processors (which are designed to achieve high average performance on a broad set of applications) and special-purpose processors (which are designed to achieve high performance on a single application). The SPE 1100 is designed to achieve high performance on game applications, media applications, broadband systems, etc., and to provide a high degree of control to programmers of real-time applications. Some capabilities of the SPE 1100 include graphics geometry pipelines, surface subdivision, Fast Fourier Transforms, image processing keywords, stream processing, MPEG encoding/decoding, encryption, decryption, device driver extensions, modeling, game physics, content creation, and audio synthesis and processing.

The synergistic processing element 1100 includes two basic functional units, namely a streaming processing unit (SPU) 1120 and a memory flow controller (MFC) 1140. The SPU 1120 performs program execution, data manipulation, etc., while the MFC 1140 performs functions related to data transfers between the SPU 1120 and the DRAM 1600 of the system.

The SPU 1120 includes a local memory 1121, an instruction unit (IU) 1122, registers 1123, one or more floating point execution stages 1124 and one or more fixed point execution stages 1125. The local memory 1121 is preferably implemented using single-ported random access memory, such as an SRAM. Whereas most processors reduce latency to memory by employing caches, the SPU 1120 implements the relatively small local memory 1121 rather than a cache. Indeed, in order to provide consistent and predictable memory access latency for programmers of real-time applications (and other applications as mentioned herein) a cache memory architecture within the SPU 1120 is not preferred. The cache hit/miss characteristics of a cache memory results in volatile memory access times, varying from a few cycles to a few hundred cycles. Such volatility undercuts the access timing predictability that is desirable in, for example, real-time application programming. Latency hiding may be achieved in the local memory SRAM 1121 by overlapping DMA transfers with data computation. This provides a high degree of control for the programming of real-time applications. As the latency and instruction overhead associated with DMA transfers exceeds that of the latency of servicing a cache miss, the SRAM local memory approach achieves an advantage when the DMA transfer size is sufficiently large and is sufficiently predictable (e.g., a DMA command can be issued before data is needed).

A program running on a given one of the synergistic processing elements 1100 references the associated local memory 1121 using a local address. However, each location of the local memory 1121 is also assigned a real address (RA) within the memory map of the overall system. This allows Privilege Software to map a local memory 1121 into the Effective Address (EA) of a process to facilitate DMA transfers between one local memory 1121 and another local memory 1121. The PPE 1200 can also directly access the local memory 1121 using an effective address. In a preferred embodiment, the local memory 1121 contains 556 kilobytes of storage, and the capacity of registers 1123 is 128×128 bits.

The SPU 1120 is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the IU 1122 includes an instruction buffer, instruction decode circuitry, dependency check circuitry, and instruction issue circuitry.

The instruction buffer preferably includes a plurality of registers that are coupled to the local memory 1121 and operable to temporarily store instructions as they are fetched. The instruction buffer preferably operates such that all the instructions leave the registers as a group, i.e., substantially simultaneously. Although the instruction buffer may be of any size, it is preferred that it is of a size not larger than about two or three registers.

In general, the decode circuitry breaks down the instructions and generates logical micro-operations that perform the function of the corresponding instruction. For example, the logical micro-operations may specify arithmetic and logical operations, load and store operations to the local memory 1121, register source operands and/or immediate data operands. The decode circuitry may also indicate which resources the instruction uses, such as target register addresses, structural resources, function units and/or busses. The decode circuitry may also supply information indicating the instruction pipeline stages in which the resources are required. The instruction decode circuitry is preferably operable to substantially simultaneously decode a number of instructions equal to the number of registers of the instruction buffer.

The dependency check circuitry includes digital logic that performs testing to determine whether the operands of given instruction are dependent on the operands of other instructions in the pipeline. If so, then the given instruction should not be executed until such other operands are updated (e.g., by permitting the other instructions to complete execution). It is preferred that the dependency check circuitry determines dependencies of multiple instructions dispatched from the decode circuitry simultaneously.

The instruction issue circuitry is operable to issue the instructions to the floating point execution stages 1124 and/or the fixed point execution stages 1125.

The registers 1123 are preferably implemented as a relatively large unified register file, such as a 128-entry register file. This allows for deeply pipelined high-frequency implementations without requiring register renaming to avoid register starvation. Renaming hardware typically consumes a significant fraction of the area and power in a processing system. Consequently, advantageous operation may be achieved when latencies are covered by software loop unrolling or other interleaving techniques.

Preferably, the SPU 1120 is of a superscalar architecture, such that more than one instruction is issued per clock cycle. The SPU 1120 preferably operates as a superscalar to a degree corresponding to the number of simultaneous instruction dispatches from the instruction buffer, such as between 2 and 3 (meaning that two or three instructions are issued each clock cycle). Depending upon the required processing power, a greater or lesser number of floating point execution stages 1124 and fixed point execution stages 1125 may be employed. In a preferred embodiment, the floating point execution stages 1124 operate at a speed of 32 billion floating point operations per second (32 GFLOPS), and the fixed point execution stages 1125 operate at a speed of 32 billion operations per second (32 GOPS).

The MFC 1140 preferably includes a direct memory access controller (DMAC) 1141, a memory management unit (MMU) 1142, and a bus interface unit (BIU) 1143. With the exception of the DMAC 1141, the MFC 1140 preferably runs at half frequency (half speed) as compared with the SPU 1120 and the bus 1500 to meet low power dissipation design objectives. The MFC 1140 is operable to handle data and instructions coming into the SPE 1100 from the bus 1500, provides address translation for the DMAC, and snoop-operations for data coherency. The BIU 1143 provides an interface between the bus 1500 and the MMU 1142 and DMAC 1141. Thus, the SPE 1100 (including the SPU 1120 and the MFC 1140) and the DMAC 1141 are connected physically and/or logically to the bus 1500.

The MMU 1142 is preferably operable to translate effective addresses (taken from DMA commands) into real addresses for memory access. For example, the MMU 1142 may translate the higher order bits of the effective address into real address bits. The lower-order address bits, however, are preferably untranslatable and are considered both logical and physical for use to form the real address and request access to memory. In one or more embodiments, the MMU 1142 may be implemented based on a 64-bit memory management model, and may provide 2⁶⁴ bytes of effective address space with 4K-, 64K-, 1M-, and 16M-byte page sizes and 256 MB segment sizes. Preferably, the MMU 1142 is operable to support up to 2⁶⁵ bytes of virtual memory, and 2⁴² bytes (4 TeraBytes) of physical memory for DMA commands. The hardware of the MMU 1142 may include an 8-entry, fully associative SLB, a 256-entry, 4 way set associative TLB, and a 4×4 Replacement Management Table (RMT) for the TLB—used for hardware TLB miss handling.

The DMAC 1141 is preferably operable to manage DMA commands from the SPU 1120 and one or more other devices such as the PPE 1200 and/or the other SPUs. There may be three categories of DMA commands: Put commands, which operate to move data from the local memory 1121 to the shared memory 1600; Get commands, which operate to move data into the local memory 1121 from the shared memory 1600; and Storage Control commands, which include SLI commands and synchronization commands. The synchronization commands may include atomic commands, send signal commands, and dedicated barrier commands. In response to DMA commands, the MMU 1142 translates the effective address into a real address and the real address is forwarded to the BIU 1143.

The SPU 1120 preferably uses a channel interface and data interface to communicate (send DMA commands, status, etc.) with an interface within the DMAC 1141. The SPU 1120 dispatches DMA commands through the channel interface to a DMA queue in the DMAC 1141. Once a DMA command is in the DMA queue, it is handled by issue and completion logic within the DMAC 1141. When all bus transactions for a DMA command are finished, a completion signal is sent back to the SPU 1120 over the channel interface.

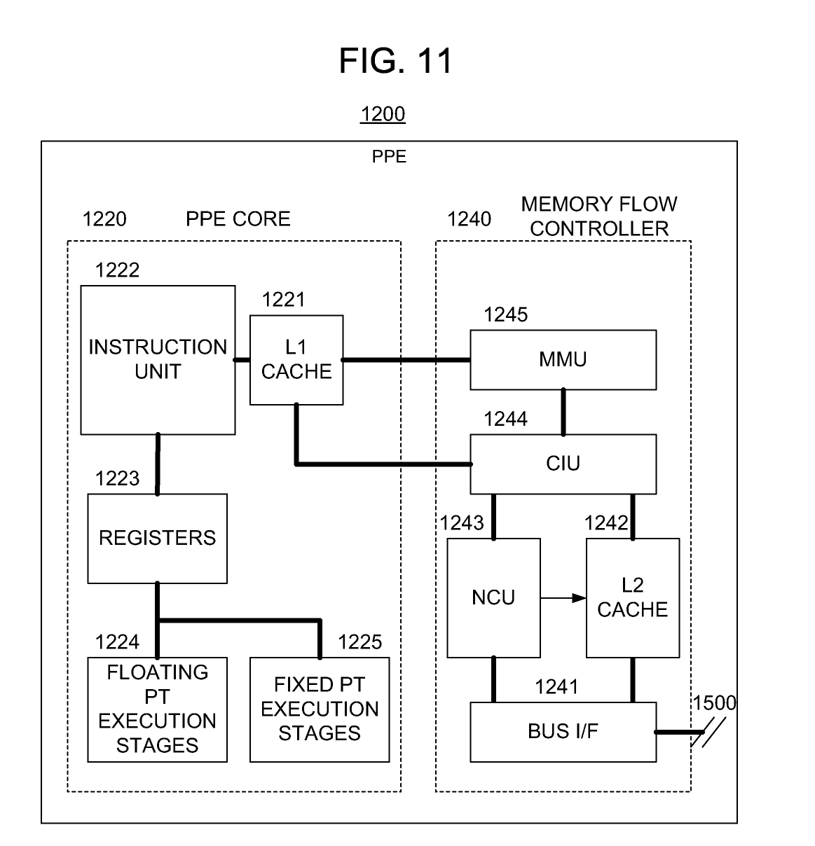

Referring to FIG. 11, a preferred structure of the PPE 1200 is illustrated. The PPE 1200 includes two basic functional units, the PPE core 1220 and the memory flow controller (MFC) 1240. The PPE core 1220 performs program execution, data manipulation, multi-processor management functions, etc., while the MFC 1240 performs functions related to data transfers between the PPE core 1220 and the memory space of the system 100.

The PPE core 1220 may include an L1 cache 1221, an instruction unit 1222, registers 1223, one or more floating point execution stages 1224 and one or more fixed point execution stages 1225. The L1 cache 1221 provides data caching functionality for data received from the shared memory 1600, the processors 1100, or other portions of the memory space through the MFC 1240. As the PPE core 1220 is preferably implemented as a superpipeline, the instruction unit 1222 is preferably implemented as an instruction pipeline with many stages, including fetching, decoding, dependency checking, issuing, etc. The PPE core 1220 is also preferably of a superscalar configuration, whereby more than one instruction is issued from the instruction unit 1222 per clock cycle. To achieve a high processing power, the floating point execution stages 1224 and the fixed point execution stages 1225 include a plurality of stages in a pipeline configuration. Depending upon the required processing power, a greater or lesser number of floating point execution stages 1224 and fixed point execution stages 1225 may be employed.

The MFC 1240 includes a bus interface unit (BIU) 1241, an L2 cache memory 1242, a non-cachable unit (NCU) 1243, a core interface unit (CIU) 1244, and a memory management unit (MMU) 1245. Most of the MFC 1240 runs at half frequency (half speed) as compared with the PPE core 1220 and the bus 1500 to meet low power dissipation design objectives.

The BIU 1241 provides an interface between the bus 1500 and the L2 cache 1242 and NCU 1243 logic blocks. To this end, the BIU 1241 may act as a Master as well as a Slave device on the bus 1500 in order to perform fully coherent memory operations. As a Master device it may source load/store requests to the bus 1500 for service on behalf of the L2 cache 1242 and the NCU 1243. The BIU 1241 may also implement a flow control mechanism for commands which limits the total number of commands that can be sent to the bus 1500. The data operations on the bus 1500 may be designed to take eight beats and, therefore, the BIU 1241 is preferably designed around 128 byte cache-lines and the coherency and synchronization granularity is 128 KB.

The L2 cache memory 1242 (with supporting hardware logic) is preferably designed to cache 512 KB of data. For example, the L2 cache 1242 may handle cacheable loads/stores, data pre-fetches, instruction fetches, instruction pre-fetches, cache operations, and barrier operations. The L2 cache 1242 is preferably an 8-way set associative system. The L2 cache 1242 may include six reload queues matching six (6) castout queues (e.g., six RC machines), and eight (64-byte wide) store queues. The L2 cache 1242 may operate to provide a backup copy of some or all of the data in the L1 cache 1221. Advantageously, this is useful in restoring state(s) when processing nodes are hot-swapped. This configuration also permits the L1 cache 1221 to operate more quickly with fewer ports, and permits faster cache-to-cache transfers (because the requests may stop at the L2 cache 1242). This configuration also provides a mechanism for passing cache coherency management to the L2 cache memory 1242.

The NCU 1243 interfaces with the CIU 1244, the L2 cache memory 1242, and the BIU 1241 and generally functions as a queuing/buffering circuit for non-cacheable operations between the PPE core 1220 and the memory system. The NCU 1243 preferably handles all communications with the PPE core 1220 that are not handled by the L2 cache 1242, such as cache-inhibited load/stores, barrier operations, and cache coherency operations. The NCU 1243 is preferably run at half speed to meet the aforementioned power dissipation objectives.

The CIU 1244 is disposed on the boundary of the MFC 1240 and the PPE core 1220 and acts as a routing, arbitration, and flow control point for requests coming from the execution stages 1224, 1225, the instruction unit 1222, and the MMU unit 1245 and going to the L2 cache 1242 and the NCU 1243. The PPE core 1220 and the MMU 1245 preferably run at full speed, while the L2 cache 1242 and the NCU 1243 are operable for a 2:1 speed ratio. Thus, a frequency boundary exists in the CIU 1244 and one of its functions is to properly handle the frequency crossing as it forwards requests and reloads data between the two frequency domains.

The CIU 1244 is comprised of three functional blocks: a load unit, a store unit, and reload unit. In addition, a data pre-fetch function is performed by the CIU 1244 and is preferably a functional part of the load unit. The CIU 1244 is preferably operable to: (i) accept load and store requests from the PPE core 1220 and the MMU 1245; (ii) convert the requests from full speed clock frequency to half speed (a 2:1 clock frequency conversion); (iii) route cachable requests to the L2 cache 1242, and route non-cachable requests to the NCU 1243; (iv) arbitrate fairly between the requests to the L2 cache 1242 and the NCU 1243; (v) provide flow control over the dispatch to the L2 cache 1242 and the NCU 1243 so that the requests are received in a target window and overflow is avoided; (vi) accept load return data and route it to the execution stages 1224, 1225, the instruction unit 1222, or the MMU 1245; (vii) pass snoop requests to the execution stages 1224, 1225, the instruction unit 1222, or the MMU 1245; and (viii) convert load return data and snoop traffic from half speed to full speed.

The MMU 1245 preferably provides address translation for the PPE core 440A, such as by way of a second level address translation facility. A first level of translation is preferably provided in the PPE core 1220 by separate instruction and data ERAT (effective to real address translation) arrays that may be much smaller and faster than the MMU 1245.

In a preferred embodiment, the PPE 1200 operates at 4-6 GHz, 10F04, with a 64-bit implementation. The registers are preferably 64 bits long (although one or more special purpose registers may be smaller) and effective addresses are 64 bits long. The instruction unit 1222, registers 1223 and execution stages 1224 and 1225 are preferably implemented using PowerPC technology to achieve the (RISC) computing technique.

Additional details regarding the modular structure of this computer system may be found in U.S. Pat. No. 6,526,491, the entire disclosure of which is hereby incorporated by reference.

In accordance with at least one further aspect of the present invention, the methods and apparatus described above may be achieved utilizing suitable hardware, such as that illustrated in the figures. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. Furthermore, although the apparatus illustrated in the figures are shown as being partitioned into certain functional blocks, such blocks may be implemented by way of separate circuitry and/or combined into one or more functional units. Still further, the various aspects of the invention may be implemented by way of software and/or firmware program(s) that may be stored on suitable storage medium or media (such as floppy disk(s), memory chip(s), etc.) for transportability and/or distribution.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
dynamically determining unit-AC paths between a plurality of processing units and a plurality of address concentrators (“AC”).

2. The method of claim 1, further comprising:
configuring a plurality of selector settings of a plurality of selector circuits;
wherein the plurality of selector circuits, the plurality of selector settings and the plurality of address concentrators combine to enable a plurality of possible AC connections.

3. The method of claim 2, further comprising notifying one or more of the address concentrators regarding the plurality of selector settings.

4. The method of claim 2, further comprising reconfiguring one or more of the plurality selector settings.

5. The method of claim 4, further comprising updating one or more of the address concentrators regarding the reconfigured selector settings.

6. The method of claim 2, wherein the plurality of selector settings are configurable in accordance with a prioritization of the processing units and/or the unit-AC paths in view of a ranking of the plurality of possible AC connections.

7. The method of claim 6, further comprising
identifying a change in the prioritization of the units and/or unit-AC paths that creates a priority mismatch between a first unit-AC path and a first AC connection associated with the first unit-AC path;
wherein a current prioritization reflects the change in the prioritization.

8. The method of claim 7, further comprising:
updating one or more of the address concentrators regarding the change in prioritization or the current prioritization.

9. The method of claim 7, further comprising reconfiguring one or more of the plurality selector settings to eliminate the priority mismatch.

10. The method of claim 9, further comprising:
updating one or more of the address concentrators regarding the reconfigured selector settings.

11. A processing system, comprising:
a plurality of processing units capable of being coupled to a shared memory;
a plurality of address concentrators capable of being coupled to the processing units, the capability of coupling of the address concentrators and processing units enabling a plurality of possible AC connections; and
a plurality of selector circuits operable to dynamically determine a plurality of unit-AC paths between the plurality of processing units and the plurality of address concentrators by forming a plurality of AC connections according to a plurality of selector settings of the plurality of selector circuits.

12. The processing system of claim 11, further comprising:
a controller circuit operable to dynamically configure the selector circuits to set the plurality of selector settings.

13. The processing system of claim 12 wherein the plurality of selector settings are configurable according to a prioritization of the units and/or unit-AC paths.

14. The processing system of claim 13, wherein:
the controller circuit is operable to identify a change in the prioritization of the units and/or unit-AC paths that creates a priority mismatch between a first unit-AC path and a first AC connection associated with the first unit-AC path;
wherein a current prioritization reflects the change in the prioritization.

15. The processing system of claim 14, wherein:
the controller circuit is operable to update one or more of the address concentrators regarding the change in prioritization or the current prioritization.

16. The processing system of claim 14, wherein:
the controller circuit is operable to reconfigure one or more of the plurality selector settings to eliminate the priority mismatch.

17. The processing system of claim 16, wherein:
the controller circuit is operable to update one or more of the address concentrators regarding the reconfigured selector settings.

18. The processing system of claim 11, further comprising a local memory coupled to each processing unit, each processing unit being operable to initiate transfer of data between the shared memory and the local memory such that data may be manipulated within the local memory.

19. The processing system of claim 18, wherein the processing units and the local memories are disposed on a common semiconductor substrate.

20. The processing system of claim 19, wherein the processing units, the local memories, and the shared memory are disposed on a common semiconductor substrate.

21. An apparatus, comprising:
a first processing system, including:
a plurality of processing units capable of being coupled to a shared memory;
a plurality of address concentrators capable of being coupled to the processing units, the capability of coupling of the address concentrators and processing units enabling a plurality of possible AC connections; and
a plurality of selector circuits operable to determine a plurality of unit-AC paths between the plurality of processing units and the plurality of address concentrators by forming a plurality of AC connections according to a plurality of selector settings of the plurality of selector circuits;
at least one further processing system, each further processing system including:
a plurality of further processing units capable of being coupled to the shared memory;
a plurality of further address concentrators capable of being coupled to the further processing units, the capability of coupling of the further address concentrators and further processing units enabling a plurality of further possible AC connections; and
a plurality of further selector circuits operable to determine a plurality of further unit-AC paths between the plurality of further processing units and the plurality of further address concentrators by forming a plurality of further AC connections according to a plurality of further selector settings of the plurality of further selector circuits;
and a controller circuit operable to dynamically configure the selector circuits to set the selector settings and also operable to dynamically configure the further selector circuits to set the further selector settings of the further selector circuits.

22. The apparatus of claim 21, wherein:
the controller circuit is operable to configure the selector circuits according to a prioritization of the processing units and/or unit-AC paths and also operable to configure the further selector circuits according to a further prioritization of the further processing units and/or further unit-AC paths.

23. The apparatus of claim 22, wherein:
the controller circuit is operable to identify a change in the prioritization or the further prioritization that creates a priority mismatch between a first unit-AC path and a first AC connection assigned to the first unit-AC path;
wherein a current prioritization set reflects the change among the prioritization and the further prioritization.

24. The apparatus of claim 23, wherein:
the controller circuit is operable to update one or more of the address concentrators and further address concentrators regarding the change or the current prioritization set.

25. The apparatus of claim 23, wherein:
the controller circuit is operable to reconfigure one or more of the plurality selector settings and further selector settings to eliminate the priority mismatch.

26. The apparatus of claim 25, wherein:
the controller circuit is operable to update one or more of the address concentrators and further address concentrators regarding the reconfigured selector settings.

27. The apparatus of claim 21, further comprising:
a local memory coupled to each processing unit, each processing unit being operable to initiate transfer of data between the shared memory and the local memory such that data may be manipulated within the local memory.

28. The apparatus of claim 27, wherein:
the first processing system is disposed on a common semiconductor substrate; and
each further processing system is disposed on a further common semiconductor substrate.

29. The apparatus of claim 28, wherein:
the shared memory also is disposed on the common semiconductor substrate.

30. The apparatus of claim 28, wherein:
the common semiconductor substrate and each further common semiconductor substrate comprise a single semiconductor substrate.

31. A computer-readable storage medium containing computer-executable instructions capable of causing a processing system to perform actions, the actions comprising:
dynamically determining unit-AC paths between a plurality of processing units and a plurality of address concentrators (“AC”).

32. The computer-readable storage medium of claim 31, the actions further comprising:
configuring a plurality of selector settings of a plurality of selector circuits;
wherein the plurality of selector circuits, the plurality of selector settings and the plurality of address concentrators combine to enable a plurality of possible AC connections.

33. The computer-readable storage medium of claim 32, the actions further comprising:
notifying one or more of the address concentrators regarding the plurality of selector settings.

34. The computer-readable storage medium of claim 32, the actions further comprising:
reconfiguring one or more of the plurality selector settings.

35. The computer-readable storage medium of claim 34, the actions further comprising:
updating one or more of the address concentrators regarding the reconfigured selector settings.

36. The computer-readable storage medium of claim 32, wherein:
the plurality of selector settings are configurable in accordance with a prioritization of the processing units and/or the unit-AC paths in view of a ranking of the plurality of possible AC connections.

37. The computer-readable storage medium of claim 36, the actions further comprising
identifying a change in the prioritization of the units and/or unit-AC paths that creates a priority mismatch between a first unit-AC path and a first AC connection associated with the first unit-AC path;
wherein a current prioritization reflects the change in the prioritization.

38. The computer-readable storage medium of claim 37, the actions further comprising:
reconfiguring one or more of the plurality selector settings to eliminate the priority mismatch.

39. The computer-readable storage medium of claim 38, the actions further comprising:
updating one or more of the address concentrators regarding the change in prioritization or the current prioritization.

40. The computer-readable storage medium of claim 38, further comprising:
updating one or more of the address concentrators regarding the reconfigured selector settings.
